(19) United States
(12) Patent Application Publication
(10) Pub. No.: US 2007/0077046 A1
(43) Pub. Date: Apr. 5, 2007

(54) Photographing apparatus and method using movement detection

(75) Inventor: Seok-Hun Lim, Suwon-si (KR)

Correspondence Address: DILWORTH & BARRESE, LLP, 333 EARLE OVINGTON BLVD., SUITE 702, UNIONDALE, NY, 11553, US

(73) Assignee: Samsung Electronics Co., Ltd., Suwon-si (KR)

(21) Appl. No.: 11/523,288

(22) Filed: Sep. 19, 2006

(30) Foreign Application Priority Data
Oct. 5, 2005 (KR) 2005-0093377

(51) Int. Cl. G03B 17/00

(52) U.S. Cl. 396/52; 396/89

(57) ABSTRACT

Provided is a photographing apparatus and method using a movement detection. In the method, a movement of a photographing apparatus in a photographing mode is measured and it is determined whether the photographing apparatus is in a fixed state. When it is determined that the photographing apparatus is in the fixed state, an auto-focusing of an object to be photographed is performed. When a photographing event is generated, an image of the object is photographed using the auto-focusing.

### PRIORITY

This application claims priority under 35 U.S.C. § 119 to an application entitled “Apparatus And Method For Photographing by Movement Detection” filed in the Korean Intellectual Property Office on Oct. 5, 2005 and allocated Serial No. 2005-93377, the contents of which are incorporated herein by reference.

### BACKGROUND OF THE INVENTION

1. Field of the Invention

The present invention relates generally to a photographing apparatus and method using a movement detection in which a movement of the photographing apparatus is detected using a movement detection unit, it is determined that the photographing apparatus is in a fixed state, i.e., a photographing standby status, when the movement of the photographing apparatus is below a reference value, and then performing an auto-focusing of the photographing apparatus.

2. Description of the Related Art

Presently, portable communication terminals such as mobile terminals, Personal Digital Assistants (PDAs), etc. are widely used. In addition to phone communication, schedule management, and other basic functions, modern portable communication terminals are being manufactured with an increasing variety of applications, including still image and video recording using built-in digital cameras, receiving and playing satellite TV broadcasts, document editing, and games.

In particular, unlike a digital camera, a mobile terminal having a camera has no half-shutter key for auto focusing whether to have Auto Focus (AF) function, unlike a digital camera, thus after an image photographing key is pressed, auto focusing is performed and an image is photographed. Thus, the terminal users frequently fail to photograph a desired image because it takes a long time to press the photographing key and photograph an image.

Therefore, in the mobile terminals not having the half-shutter key, it is required to perform an auto focusing in advance, thereby shortening the photographing time.

### SUMMARY OF THE INVENTION

An object of the present invention is to substantially solve at least the above described problems and/or disadvantages and to provide at least the advantages described herein below. Accordingly, an aspect of the present invention is to provide a photographing apparatus and method using movement detection that can determine whether the photographing apparatus is in a fixed status and thereby perform an auto-focusing when the photographing apparatus is in a fixed status.

Another aspect of the present invention is to provide a photographing apparatus and method for detecting a movement of the photographing apparatus using a movement detection unit. Upon determining that the photographing apparatus is in a fixed status, i.e., a photographing idle mode, when the movement of the photographing apparatus is below a reference value, an auto-focusing of the photographing apparatus is performed.

According to an aspect of the present invention, a photographing apparatus using a movement detection, includes a movement detection unit for measuring a movement of the photographing apparatus; a camera unit for auto-focusing an object to be photographed and photographing the object; and a controller which, in a photographing mode, determines whether the photographing apparatus is in a fixed status using the movement of the photographing apparatus measured by the movement detection unit, and upon determining that the photographing apparatus is in a fixed status, controls the camera unit to auto-focus the object.

According to another aspect of the present invention, a photographing method using a movement detection, includes measuring a movement of a photographing apparatus in a photographing mode and determining whether the photographing apparatus is in a fixed status; upon determining that the photographing apparatus is in the fixed status, performing an auto-focusing of an object to be photographed; and when a photographing event is generated, photographing an image of the object using the auto-focusing.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a portable communication terminal having a photographing function using a movement detection according to the present invention; and

FIG. 2 is a flow diagram illustrating a photographing method using a movement detection in a photographing apparatus having a movement detection unit according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

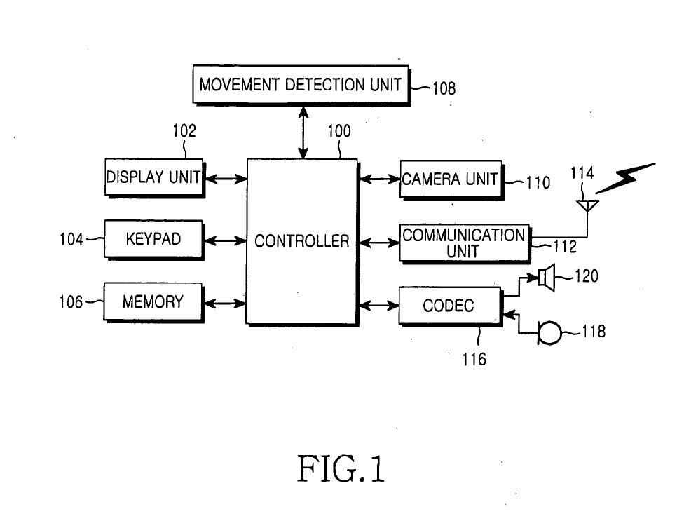

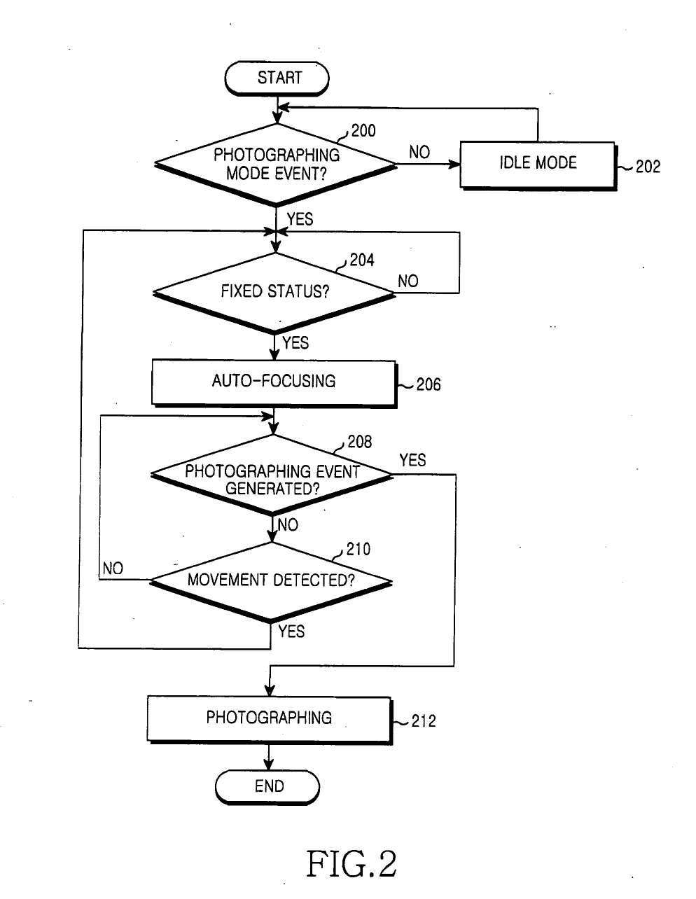

The present invention relates to a photographing apparatus and method using movement detection in which the photographing apparatus is determined to be in a fixed state when a degree of movement of the photographing apparatus is below a reference value, and then performing an auto focusing. Hereinafter, the photographing apparatus and method according to embodiments of the present invention will be described in detail with reference to FIGS. 1 and 2.

FIG. 1 is a block diagram illustrating a portable communication terminal having a photographing function using movement detection according to the present invention.

Hereinafter, a portable communication terminal of the present invention provided with a movement detection unit and a camera module includes, but is not limited to, a cellular phone, a Personal Communication System (PCS), a Personal Data Assistant (PDA), and an International Mobile Telecommunication-2000 (IMT-2000) terminal. However, the invention should not be construed as being limited to the embodiments set forth herein; rather, these embodiments can be applicable to all photographing apparatuses having a movement detection unit and a camera module. The following description will be made with reference to a general construction of the terminals.

Referring to FIG. 1, a portable communication terminal of the present invention includes a controller 100, a display unit 102, a keypad 104, a memory 106, a movement detection unit 108, a camera unit 110, a communication unit 112, an antenna 114, a codec 116, a microphone 118 and a speaker 120.

The controller 100 controls an overall operation of the portable communication terminal. For example, the controller 100 processes and controls a voice communication as well as a data communication. In addition to the general functions, the controller 100 detects movement of the portable communication terminal using the movement detection unit 108 in a photographing mode. When the detected movement is below a reference value, the controller 100 determines the portable communication terminal to be in a fixed state and performs an auto-focusing. When a photographing event occurs, the controller 100 controls a photographing operation with the auto-focusing.

The display unit 102 displays, but is not limited to displaying, status information (or indicator) generated during operations, numerals and characters, moving pictures and still pictures. A color Liquid Crystal Display (LCD) may be used for the display unit 102.

The keypad 104 includes numeric keys of digits 0-9 and a plurality of function keys, such as a Menu key, a Cancel (Delete) key, a Confirmation key, a Talk key, an End key, an Internet Connection key, and Navigation keys [symbol] to provide key input data that corresponds to a key pressed by a user to the controller 100.

The memory 106 stores a program for controlling an overall operation of the portable communication terminal. Also, the memory 106 temporarily stores data generated during operations and complementary data (e.g., telephone number, SMS message, picture data, and etc.).

The movement detection unit 108 measures a movement status information of the portable communication terminal, for example, an acceleration. That is, the movement detection unit 108 measures the acceleration in three axes of X-axis, Y-axis and Z-axis and then measures a rotational angle, a slope and a movement of the portable communication terminal using a variation in the acceleration.

The camera unit 110 includes a Charge Coupled Device (CCD) or a Complementary Metal Oxide Semiconductor (CMOS) which receives a light signal of an object to be photographed and converts the light signal input through lenses into an electrical signal.

The communication unit 112, during a reception operation, down-converts a Radio Frequency (RF) signal received through the antenna 114 and despreads as well as channel-decodes the received RF signal, and during a transmission operation, channel-codes and spreads data to be transmitted, up-converts a signal carrying the data and transmits the up-converted signal. Also, the communication unit 112 receives a Base Station (BS) Identification (ID) number through a received pilot channel.

The Coder/Decoder (codec) 116 is connected to the controller 100, and the microphone 118 together with the speaker 120 are connected to the codec 116. The codec 116, the microphone 118, and the speaker 120 serve as an audio input/output block for a voice communication. The controller 100 produces Pulse-Code Modulation (PCM) data and the codec 116 converts the PCM data into analog audio signals. The analog audio signals are outputted through the speaker 120. The codec 116 also converts audio signals received through the microphone 118 into PCM data and then provides the PCM data to the controller 100.

FIG. 2 is a flow diagram illustrating a photographing method using a movement detection in a photographing apparatus having a movement detection unit according to the present invention

Referring to FIG. 2, in step 202, the portable communication terminal is in an idle mode. The process proceeds to step 200, and in step 200, it is determined whether a photographing mode event is generated. Upon failure to generate the photographing mode event the process returns to step 202 and is maintained in the idle mode. Upon generating the photographing mode event, the process proceeds to step 204. In step 204, the movement detection unit 108 measures a movement of the photographing apparatus by the movement detection unit 108, and it is determined whether the photographing apparatus is in a fixed state in which the measured movement is below a preset reference value and is maintained for a predetermined time interval.

In the determining step 204, when the photographing apparatus is not in the fixed state, the step 204 is repeated until the photographing apparatus is in a fixed state. In step 204, when the photographing apparatus is in the fixed state, the process proceeds to step 206, where an auto-focusing of the object is performed, and then the process proceeds to step 208. In step 208, it is determined whether a photographing event is generated. In step 208, when the photographing event is generated, the process proceeds to step 212 where photographing the object is performed using the auto-focus obtained in step 206.

In step 210, when the measured movement of the photographing apparatus is greater than the preset reference value, the process returns to step 204 in order to perform auto-focusing, and it is determined whether the photographing apparatus is in a fixed state. In step 210, when the measured movement of the photographing apparatus is not greater than the preset reference value, i.e., in the fixed state, the process proceeds to step 208, and it is determined whether a photographing event is generated.

In step 208, when the photographing event is generated, the process proceeds to step 212 where photographing of the object is performed using the auto-focus obtained in step 206.

As described above, according to the present invention, movement of the photographing apparatus is measured to determine whether the photographing apparatus is in a fixed state. As a result of determining, when the photographing apparatus is in the fixed state, an auto-focusing is performed. When a photographing event is generated, an image of an object is photographed. Thus, in the present invention, the auto-focusing is performed in advance of pressing the photographing key is thereby shortening the photographing time and allowing a user to photograph a desired image.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention can be construed by programmers of ordinary skill in the art to which the present invention pertains.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable terminal having a photographing apparatus using movement detection, the photograph apparatus comprising:
a movement detection unit for measuring movement of a portable terminal;
a controller for determining, in a photographing mode, whether the portable terminal is in a fixed state using the movement of the portable terminal measured by the movement detection unit, and if in a fixed state, controlling the camera unit to auto-focus the object; and
a camera unit for auto-focusing an object to be photographed and photographing the object according to a control of the controller.

2. The portable terminal of claim 1, wherein the movement detection unit measures acceleration in three axes of an X-, a Y-, and a Z-axis and then measures the movement of the portable terminal using variations in the acceleration.

3. The portable terminal of claim 1, wherein the controller determines the portable terminal to be in the fixed state when the movement of the portable terminal measured by the movement detection unit is below a preset reference value.

4. The portable terminal of claim 1, wherein the controller controls the photographing apparatus to photograph the image of the object when the auto-focusing is performed and then a photographing event is generated.

5. A photographing method using a movement detection in a portable terminal, comprising the steps of:
measuring movement of a photographing apparatus in a photographing mode and determining whether the photographing apparatus is in a fixed state;
when it is determined that the photographing apparatus is in the fixed state, performing an auto-focusing of an object to be photographed; and
when a photographing event is generated, photographing an image of the object using the auto-focusing.

6. The photographing method of claim 5, after the step of performing the auto-focusing, before the photographing event is generated, when the movement of the photographing apparatus is greater than a preset reference value, further comprising
determining whether the photographing apparatus is in the fixed state;
when it is determined that the photographing apparatus is in the fixed state, again performing the auto-focusing.

7. The method of claim 6, wherein it is determined that the photographing apparatus is in the fixed state when the movement of the photographing apparatus is below the preset reference value.

8. A photographing apparatus using movement detection in a portable terminal, comprising:
a controller for controlling the camera unit to auto-focus an object to be photographed if a portable terminal is in a fixed state when the portable terminal is in a photograph mode; and
a camera unit for auto-focusing the object.

9. The photographing apparatus of claim 8, further comprising a movement detection unit for measuring movement of the portable terminal.

10. The photographing apparatus of claim 9, wherein the movement detection unit measures acceleration in three axes of an X-, a Y-, and a Z-axis and then measures the movement of the portable terminal using variation in the acceleration.

11. The photographing apparatus of claim 10, wherein the controller determines the portable terminal to be in the fixed state when variation the acceleration is below a reference value.

12. A photographing method using a movement detection in a portable terminal, comprising the steps of:
measuring movement of a portable terminal in a photographing mode; and
performing an auto-focusing of an object to be photographed when the portable terminal is in the fixed state.

13. The photographing method of claim 12, wherein the measuring step is to measure acceleration in three axes of an X-, a Y-, and a Z-axis and then the movement of the portable terminal using variations in the acceleration.

14. The photographing method of claim 13, wherein whether the portable terminal is in the fixed state is determined whether the variation the acceleration is below a reference value.

15. A computer-readable recording medium having recorded thereon a program for photographing method using a movement detection in a portable terminal, comprising:
a first code segment, for measuring movement of a portable terminal in a photographing mode; and
a second code segment, performing an auto-focusing of an object to be photographed when the portable terminal is in the fixed state.
